(19) United States
(12) Patent Application Publication
(10) Pub. No.: US 2004/0099103 A1
(43) Pub. Date: May 27, 2004

(54) Adaptive socket tool

(76) Inventor: Billy S. Vaughan, San Juan Capistrano, CA (US)

Correspondence Address: GENE SCOTT; PATENT LAW & VENTURE GROUP, 3140 RED HILL AVENUE, SUITE 150, COSTA MESA, CA, 92626-3440, US

(21) Appl. No.: 10/397,747

(22) Filed: Mar. 25, 2003

Related U.S. Application Data
(63) Continuation-in-part of application No. 10/302,152, filed on Nov. 21, 2002.

(51) Int. Cl. B25B 13/00

(52) U.S. Cl. 81/124.4

(57) ABSTRACT

A socket tool apparatus comprises a body having a central axis and opposing end surfaces. Impressed into one of the end surfaces are plural, central axis concentric, non-round, apertures of sequentially diminishing size. At the other one of the end surfaces, an aperture or a rod is positioned for attachment of the socket tool to a driver tool so as to enable the socket tool to revolve about the central axis. A spring is used to apply holding force to a fastener inserted into the socket tool.

### RELATED APPLICATIONS

This is a continuation-in-part application of a prior filed and currently pending application having Ser. No. 10/302,152 and file date of Nov. 21, 2002.

### INCORPORATION BY REFERENCE

Applicant(s) hereby incorporate herein by reference, any and all U.S. patents, U.S. patent applications, and other documents and printed matter cited or referred to in this application.

### BACKGROUND OF THE INVENTION

1. Field of the Invention

This invention relates generally to hand tools for driving fasteners and more particularly to an adaptive socket having plural concentrically oriented sockets and means for engaging a driver.

2. Description of Related Art

The following art defines the present state of this field:

Hu, U.S. Pat. No. 6,367,628 teaches a tool holder device comprising a main board, a slide seat releasably, engaged with the main board and including a plurality of pegs, and a tool holder including a plurality of receptacles with different diameters for releasably holding wrenches of various sizes. The tool holder is releasably engaged with the slide seat. Each receptacle includes a resilient holding member for releasably holding an associated wrench in place. When the tool holder is engaged with the slide seat, each peg of the slide seat is received in an associated receptacle of the tool holder, and a wrench received in the tool holder rests on an associated peg with the wrench being not held by an associated holding means, thereby allowing ready removal of the wrench from the tool holder.

Legg, U.S. Pat. No. 6,109,147 teaches a tool providing a plurality of tool bits, each having a different polygonal (i.e. hexagonal) external contour. The tool includes an inner member and an outer sleeve member. The inner member defines a small tool bit having a polygonal external contour. The outer sleeve member includes a cavity that selectively receives the inner member. The inner member and the outer sleeve member together define, when the inner member is received within the cavity, a large tool bit having a polygonal external contour of the same shape, but a larger size, than the inner tool bit. In this manner, the small tool bit may be used when the inner member is withdrawn from the cavity and the large tool bit may be used when the inner member is received within the cavity.

Hu, U.S. Pat. No. 5,938,028 teaches a tool holder including a main body having a bottom wall and a number of substantially L-shaped separation walls formed on the bottom wall, thereby defining a substantially L-shaped receiving compartment between each two adjacent separation walls. Each separation wall includes a first section and a second section. A resilient retaining member is mounted on the first section of each separation wall. Each receiving compartment includes a relatively longer section and a relatively shorter section. A guiding wall is extended across two second sections respectively of two adjacent separation walls. The guiding wall includes a downwardly extending guiding surface that faces the bottom wall. The downwardly extending guiding surface is preferably arcuate and inclines downwardly toward the bottom wall. The bottom wall includes a guiding surface section that is located below the downwardly extending guiding surface of the guiding wall and inclines downwardly along a direction parallel to the extending direction of the downwardly extending guiding surface of the guiding wall. The main body further includes a retaining wall provided to the relatively shorter section of each receiving compartment. The lower retaining wall includes an inner holding surface that faces the bottom wall. The bottom wall includes a holding surface section located above the guiding surface section. The downwardly extending guiding surface of the guiding wall and the guiding surface section of the bottom wall together guide a hexagonal wrench to be received in an associated receiving compartment. The inner holding surface of the retaining wall, the holding surface section of the bottom wall, and the retaining member together hold the hexagonal wrench in place.

The prior art teaches tool holders for hex wrenches but does not teach a socket with plural sequenced sockets arranged axially, and does not teach the use of a single continuous spring mounted for applying forces to a fastener inserted into the socket. The present invention fulfills these needs and provides further related advantages as described in the following summary.

### SUMMARY OF THE INVENTION

The present invention teaches certain benefits in construction and use which give rise to the objectives described below.

A socket tool comprises a body having a central axis and opposing end surfaces. Impressed into one of the end surfaces are plural, central axis concentric, preferably hexagonal or other non-round shape, apertures of sequentially diminishing size. At the other one of the end surfaces, an aperture or a rod is positioned for attachment of the socket tool to a driver tool so as to enable the socket tool to revolve about the central axis for turning a fastener. A spring is captured within a groove adjoining the hexagonal apertures and held in place by opposing ends of the spring inserted into opposing slots in the body. When the head of a fastener is inserted into one of the hexagonal apertures it depresses the spring and is therefore held in place by spring tension frictional forces.

A primary objective of the present invention is to provide an apparatus and method of use of such apparatus that provides advantages not taught by the prior art.

Another objective is to provide such an invention capable of driving a range of hexagonal head fasteners using a single socket tool.

A further objective is to provide such an invention capable of being mounted to a socket driver tool.

A still further objective is to provide such an invention enabled for engaging a fastener with spring tension force.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is a side view of a preferred embodiment of the invention with partial cutaway to show interior details;

FIG. 2 is a side view of a further embodiment thereof;

FIG. 3 is a still further embodiment shown as a side elevational view in full vertical section;

FIG. 4 is an end sectional view taken along line 4-4 in FIG. 3; and

FIG. 5 is the same view as illustrated in FIG. 3, shown with a fastener inserted, the fastener comprising prior art.

### DETAILED DESCRIPTION OF THE INVENTION

The above described drawing figures illustrate the invention in at least one of its preferred embodiments, which is further defined in detail in the following description.

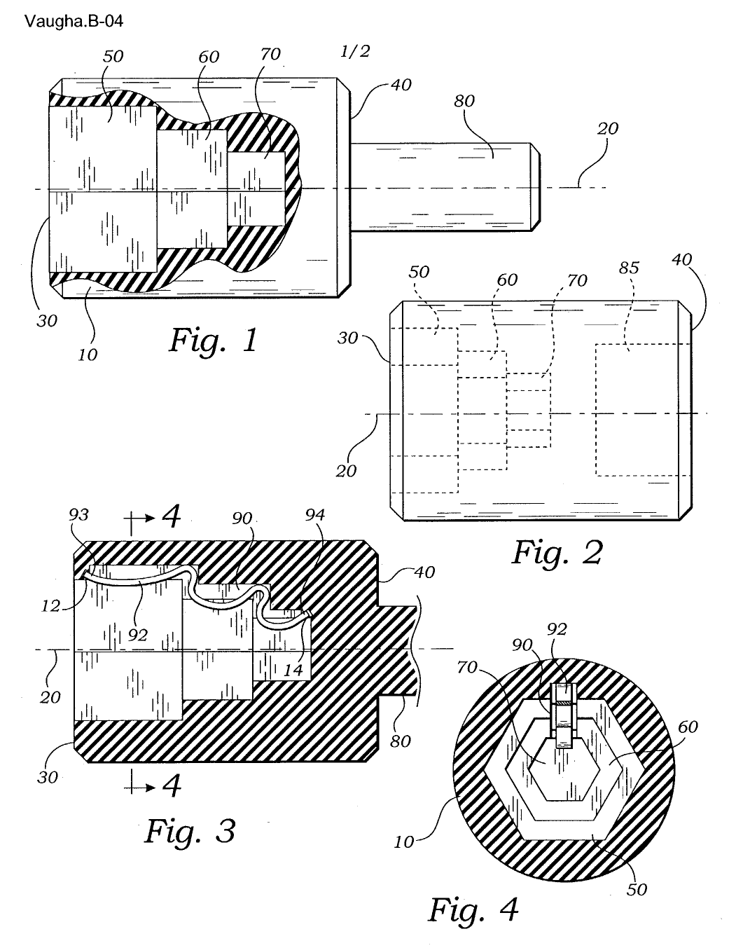

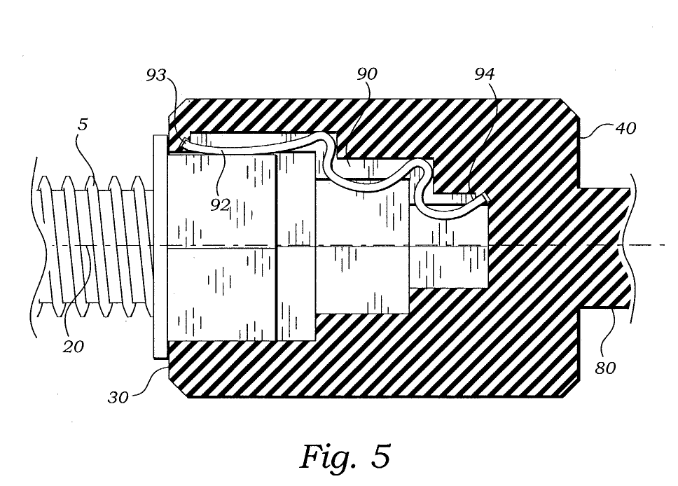

The present invention is a socket tool comprising a body 10 made of a hard and durable material such as steel. The body 10 has a central axis 20 about which the tool is rotated for driving fasteners such as that shown in FIG. 5. The body 10 also provides opposing end surfaces 30, 40. Impressed into one of the end surfaces 30, in the preferred embodiment, are plural, central axis concentric, hexagonal, apertures 50, 60, 70 of sequentially diminishing size as clearly shown in FIG. 1. However, the apertures may be other than hexagonal, as shown in FIG. 4, such as star shaped, etc., in fact any shape will function as long as it is not round. At the other one of the end surfaces 40 is a means for attachment of the socket tool to a driver tool (the driver tool is not shown), and this attachment means is adapted, by its position and orientation, for enabling the socket tool to revolve about the central axis 20 when mounted in the driver tool. Preferably, the attachment means is a rod 80 extending axially from the other one of the end surfaces 40 as shown in FIGS. 1 and 3, or the attachment means is an aperture 85 extending axially into the other one of the end surfaces 40, as shown in FIG. 2.

In one embodiment of the invention, shown in FIGS. 3 and 4, the apparatus provides a means for biased fastener engagement 90. The engagement means 90 is necessarily positioned laterally to the plural hexagonal apertures 50, 60, 70 and preferably comprises a leaf-like spring 92, of spring steel, mounted in a groove 90 adjacent to, and open to, the plural hexagonal apertures 50, 60 and 70. The groove 90 may be formed as a sequence or series of grooves as shown.

Preferably, the spring 92 is captured within the groove 90 by inserting opposing ends 93, 94 of the spring 92 into opposing slots 12, 14 respectively in the body 10 at opposing ends of the groove 90. This is best seen in FIGS. 3 and 5.

In operation, the socket tool of the present invention is attached to a driver tool as is well known in the art. The embodiment of FIG. 2 is adapted for use with a ratchet type driver commonly used by mechanics. The embodiment of FIG. 1 is adapted for use with an electric screwdriver or drill, commonly used by professionals in all trades and consumers as well, wherein the rod 80 is tightened into the chuck of such driver. To drive a hexagonal headed screw, bolt or rod (fastener), the fastener 5 is inserted into one of the hexagonal apertures 50, 60 or 70, depending on size. The portion of the spring 92 that is adjacent to aperture selected is thereby caused to deflect inwardly into groove 90 but in such deflection, spring 92 exerts its deflection spring force onto the side of the fastener 5 thereby holding the fastener in place more securely than is possible without such force. When the driving action on the fastener is complete, i.e., the fastener is either fully driven into place or removed, the socket tool is able to be easily withdrawn from the fastener, or the fastener from the socket tool.

In an alternate embodiment, the means for fastener engagement comprises the magnetization of the body 10 of the socket tool thereby enabling magnetic attraction of an iron containing fastener to the body 10 of the socket tool.

While the invention has been described with reference to at least one preferred embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

What is claimed is:

1. A socket tool apparatus comprising: a body having a central axis and opposing end surfaces; impressed into one of the end surfaces, plural, central axis concentric, non-round, apertures of sequentially diminishing size; and at the other one of the end surfaces, a means for attachment of the socket tool to a driver tool, the attachment means adapted for enabling the socket tool to revolve about the central axis.

2. The apparatus of claim 1 wherein the concentric apertures are hexagonal in shape.

3. The apparatus of claim 1 wherein the attachment means is a rod extending axially from the other one of the end surfaces.

4. The apparatus of claim 1 wherein the attachment means is an aperture extending axially into the other one of the end surfaces.

5. The apparatus of claim 1 further comprising a means for biased fastener engagement, the engagement means positioned lateral to the plural apertures.

6. The apparatus of claim 5 wherein the engagement means comprises a spring mounted in a groove adjacent and open to the plural hexagonal apertures.

7. The apparatus of claim 6 wherein the spring is captured within the groove by opposing ends of the spring inserted into opposing slots in the body.

8. The apparatus of claim 1 further comprising a means for fastener engagement, the engagement means comprising magnetization of the body of the socket tool thereby enabling magnetic attraction of an iron containing fastener to the body of the socket tool.
